(19) United States
(12) Patent Application Publication
(10) Pub. No.: US 2025/0222359 A1
(43) Pub. Date: Jul. 10, 2025

(54) COMPLEXITY ASSESSMENT

(71) Applicant: IGT, Las Vegas, NV (US)

(72) Inventors: Soheil Latifi, Brampton (CA); Michael Russ, Graz (AT); David Small, Moncton (CA)

(21) Appl. No.: 18/406,650

(22) Filed: Jan. 8, 2024

(51) Int. Cl. A63F 13/67; A63F 13/69

(52) U.S. Cl. CPC A63F 13/67; A63F 13/69

(57) ABSTRACT

Embodiments of the present disclosure are directed to operating an electronic game. According to one embodiment, a method for operating an electronic game can comprise maintaining a player experience model defining a plurality of factors indicating player engagement with the electronic game. Information related to activity of a player of the electronic game can be received from a gaming system during execution of the electronic game on the gaming system. A player engagement level can be determined based on the received information related to the activity of the player and the player experience model. In response to the determined player engagement level being less than a predetermined threshold, an instruction can be provided to the gaming system to enable an additional, new feature in the electronic game.

### BACKGROUND

The present disclosure is generally directed to operating an electronic game and more particularly to assessing player engagement and/or skill level and updating the electronic game accordingly.

EGM games can have many features. From Pick-a-Prize bonuses to free spins, different bet combinations, reel symbols, shared jackpots and in game credits. Research shows that a key factor for players is to constantly be surprised by the game. In other words, as long as that games have something new to show the players find them interesting and keep playing with them.

Although the easy solution is to add every single feature to the game, that might increase the complexity of the game to the extent that players might have a hard time understanding the game and may not like to keep on playing them.

### BRIEF SUMMARY

Embodiments of the present disclosure are directed to operating an electronic game. According to one embodiment, a method for operating an electronic game can comprise maintaining a player experience model defining a plurality of factors indicating player engagement with the electronic game. Information related to activity of a player of the electronic game can be received from a gaming system during execution of the electronic game on the gaming system. A player engagement level can be determined based on the received information related to the activity of the player and the player experience model. In response to the determined player engagement level being less than a predetermined threshold, an instruction can be provided to the gaming system to enable an additional, new feature in the electronic game. The player experience model can be trained based on the received information related to the activity of the player. Additionally, or alternatively, information related to activity of the player of the electronic game related to the additional, new feature of the electronic game can be received from the gaming system during execution of the electronic game on the gaming system and the player experience model can be trained based on the received information related to activity of the player of the electronic game related to the additional, new feature of the electronic game.

A game complexity model defining a plurality of factors indicating player proficiency with the electronic game can also be maintained. A player skill level can be determined based on the received information related to the activity of the player and the game complexity model. In response to the determined player skill level being less than a predetermined threshold for a current level of the electronic game, an instruction can be provided to the gaming system to provide a tutorial to the player of the electronic game. The game complexity model can be trained based on the received information related to the activity of the player. Additionally, or alternatively, an instruction to collect information indicating a response by the player to the provided tutorial can be provided to the gaming system and the information indicating the response by the player to the tutorial can be received from the gaming system. In such cases, the game complexity model can be trained based on the received information indicating the response by the player to the tutorial. The determined player engagement level and the determined player skill level can be saved in an electronic record associated with the player.

According to another embodiment, a system can comprise a communications interface, a processor coupled with the communications interface, and a memory coupled with and readable by the processor. The memory can store therein a set of instructions which, when executed by the processor, causes the processor to maintain a player experience model defining a plurality of factors indicating player engagement with an electronic game. The instructions can further cause the processor to receive, from a gaming system, information related to activity of a player of the electronic game during execution of the electronic game on the gaming system, determine a player engagement level based on the received information related to the activity of the player and the player experience model, and in response to the determined player engagement level being less than a predetermined threshold, provide, to the gaming system, an instruction to enable an additional, new feature in the electronic game. The instructions can further cause the processor to train the player experience model based on the received information related to the activity of the player. Additionally, or alternatively, the instructions can further cause the processor to receive, from the gaming system, information related to activity of the player of the electronic game related to the additional, new feature of the electronic game during execution of the electronic game on the gaming system and train the player experience model based on the received information related to activity of the player of the electronic game related to the additional, new feature of the electronic game.

In some cases, the instructions can further cause the processor to maintain a game complexity model, the game complexity model defining a plurality of factors indicating player proficiency with the electronic game, determine a player skill level based on the received information related to the activity of the player and the game complexity model, and in response to the determined player skill level being less than a predetermined threshold for a current level of the electronic game, provide, to the gaming system, an instruction to provide a tutorial to the player of the electronic game. The instructions can further cause the processor to train the game complexity model based on the received information related to the activity of the player. Additionally, or alternatively, the instructions can further cause the processor to provide, to the gaming system, an instruction to collect information indicating a response by the player to the provided tutorial, receive, from the gaming system, the information indicating the response by the player to the tutorial, and train the game complexity model based on the received information indicating the response by the player to the tutorial. The instructions can further cause the processor to save the determined player engagement level and the determined player skill level in an electronic record associated with the player.

According to yet another embodiment, a system can comprise a communications network, a gaming system communicatively coupled with the communications network, and a game complexity assessment system coupled with the communications network. The game complexity assessment system can comprise a processor and a memory, the memory storing therein a set of instructions which, when executed by the processor, causes the processor to maintain a player experience model, the player experience model defining a plurality of factors indicating player engagement with the electronic game, receive, from a gaming system, via the communications network, information related to activity of a player of the electronic game during execution of the electronic game on the gaming system, determine a player engagement level based on the received information related to the activity of the player and the player experience model, and in response to the determined player engagement level being less than a predetermined threshold, provide, to the gaming system, via the communications network, an instruction to enable an additional, new feature in the electronic game. The instructions can further cause the processor to train the player experience model based on the received information related to the activity of the player. Additionally, or alternatively, the instructions can further cause the processor to receive, from the gaming system, via the communications network, information related to activity of the player of the electronic game related to the additional, new feature of the electronic game during execution of the electronic game on the gaming system and train the player experience model based on the received information related to activity of the player of the electronic game related to the additional, new feature of the electronic game.

The instructions can further cause the processor to maintain a game complexity model, the game complexity model defining a plurality of factors indicating player proficiency with the electronic game, determine a player skill level based on the received information related to the activity of the player and the game complexity model, and in response to the determined player skill level being less than a predetermined threshold for a current level of the electronic game, provide, to the gaming system, via the communications network, an instruction to provide a tutorial to the player of the electronic game. The instructions further cause the processor to train the game complexity model based on the received information related to the activity of the player. Additionally, or alternatively, the instructions can further cause the processor to provide, to the gaming system, via the communications network, an instruction to collect information indicating a response by the player to the provided tutorial, receive, from the gaming system, via the communications network, the information indicating the response by the player to the tutorial, and train the game complexity model based on the received information indicating the response by the player to the tutorial.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure can be implemented.

FIG. 2 is a block diagram illustrating additional detail of components of an exemplary game complexity assessment system according to one embodiment of the present disclosure.

FIG. 3 is a block diagram illustrating additional details of components of an exemplary gaming system according to one embodiment of the present disclosure.

FIG. 4 is a flowchart illustrating an exemplary process for operating an electronic game according to one embodiment of the present disclosure.

FIG. 5 is a flowchart illustrating an exemplary process for operating an electronic game according to another embodiment of the present disclosure.

### DETAILED DESCRIPTION

Embodiments of the present disclosure are directed to assessing and tracking player engagement and/or skill level and updating an electronic game accordingly. More specifically, embodiments provide for assessing and tracking player experience, i.e., a level of engagement of the player in an electronic game, and complexity assessment relative to the player's skill level. In various embodiments, an Artificial Intelligence (AI) system can be trained on historical game play data. A player-specific AI model can be trained continuously with the player's progress made to track & reflect the player's casino familiarity or skill level and level of engagement. Based on the player's skill level explanatory actions can be triggered for the player as needed in a particular game, e.g., a tutorial or demonstration can be provided. Additionally, or alternatively, if the player's engagement level drops to a certain point, indicating that the player may be losing interest in the game, additional, new features can be added to and/or enabled in the game thereby giving the player a new challenge to increase interest and engagement.

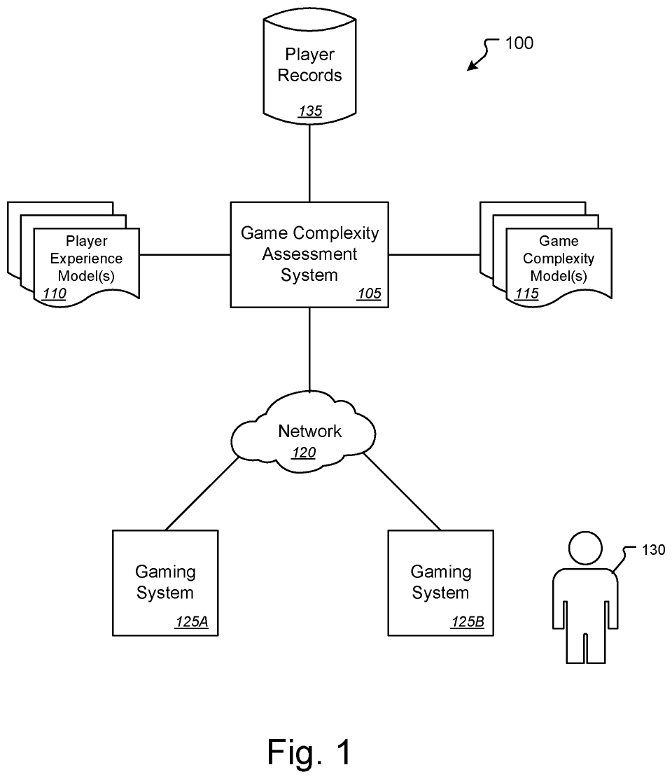

FIG. 1 is a block diagram illustrating an exemplary environment in which embodiments of the present disclosure can be implemented. As illustrated in this example, the environment 100 can include a game complexity assessment system 105. The game complexity assessment system 105 can comprise any one or more servers and/or computing devices as known in the art and which can maintain a set of player specific player experience models 110 and game complexity models 115. Which the player specific player experience models 110 and game complexity models 115 may each be related to a specific player, each may also be used by the game complexity assessment system 105 to train and refine models for new players, new games, new game features, etc. For example, the game complexity assessment system 105 can monitor a number of games and apply reinforcement learning to learn how to play the games, how players interact with the games, etc.

The environment 100 can also include a communications network 120. The communications network can comprise any one or more wired and/or wireless, local-area and/or wide-area networks as known in the art including, but not limited to, the Internet. Any number of gaming systems 125A and 125B can also be coupled with the communications network 120. The gaming systems 125A and 125B can Electronic Gaming Machines (EGMs) or other systems executing any number of electronic game including, but not limited to, slots, video slots, video poker, keno, blackjack, etc. to be played by a player, e.g., in a casino or other gaming venue. Each game and even each gaming system 125A and 125B can be assigned by the game complexity assessment system 105 a complexity degree. This can be a good solid base for the operator of a gaming venue in which the games are installed to select games with optimal complexity.

Generally speaking, the game complexity assessment system 105, using the player experience models 110 and game complexity models 115 can estimate the complexity of a game, its features, the level of player engagement in a game, the player's level of skill to determine the player's level engagement with the game and/or need for a tutorial or other assistance for a specific event. For example, the complexity assessment system can activate explanatory game actions on-the-fly when it determines that a player's 130 skill level is below a certain threshold for a particular game or game feature based on the models 110 and 115 and game information received from the gaming system 125B. In such cases, the game complexity assessment system 105 can cause the gaming system 125B to present hints, explanations, instructions, etc. In other cases, the game complexity assessment system 105 can activate new features, functionalities, game rules, etc. when it determines the player's 130 level of engagement falls below a certain level, perhaps indicating that the player is becoming bored with the game. Thus, players with lower skill levels can receive instructions in more detail and more often while new features would be added to their games rather rarely, whereas experienced players can receive instructions in less detail or not at all, and new features can be triggered more often to maintain player engagement.

According to one embodiment, the game complexity assessment system 105 can be self-updating/self-adjusting as a monitored game progresses to accurately represent a player's skill level and or level of engagement. A player's skill level can be persisted, e.g., by saving an indication of the skill level to a player record 135 associated with or representing the player's profile, e.g., based on player tracking card ID or biometric data, and automatically restore that level once the player initiates a game on a gaming system. For example, after creating a new account in a new casino and the first time the player starts playing, the game complexity system 105 might ask the player 130, through the gaming system 125B, to rate their game familiarity, to set their baseline threshold. The game complexity assessment system 105 can then track which explanations and which features have already been shown to the player and create a good player experience history. The game complexity assessment system 105 can track, based on game information received from the gaming system 125B, how often, how long, with which performance a certain feature was played. If the game complexity assessment system 105 identifies player behavior during that presentation of that feature as “unexperienced,” i.e., demonstrating a low skill level, it can trigger explanations, tutorials, hints, demonstrations, etc. on the gaming system 125B in real time and/or the next time the player 130 starts the game or feature.

According to one embodiment, the game complexity assessment system 105 can implement a mechanism of an approval loop where the player 130 might be asked occasionally, through the gaming system 125B, if a triggered tutorial, explanation, hint, demonstration, or similar action was appropriate/helpful or not. The game complexity assessment system 105 can use this feedback to train the models 110 and 115 and fine-tune when/if such actions shall be triggered in the future. Using such feedback across multiple players can help the game complexity assessment system 105 to better understand when and which actions are appropriate.

According to one embodiment, the game complexity assessment system 105 can additionally, or alternatively, provide hints to the player 130 on how to optimize the play experience to achieve optimum enjoyment based on their play history and preferences. Additionally, or alternatively, the game complexity assessment system 105 can insert new game features into the game from time to time to keep the player “surprised” and engaged. These features can be determined based on player preferences maintained in the player records 135 and/or as determined by the game complexity assessment system 105. The game complexity assessment system 105 can, through the gaming system 125B highlight the fact that a specific new feature has been added and provide whatever level of explanation is appropriate for the player 130, e.g., based on determined skill level. The game complexity assessment system 105 can, in some cases, also delete the new feature if it determines that the player did not like the feature.

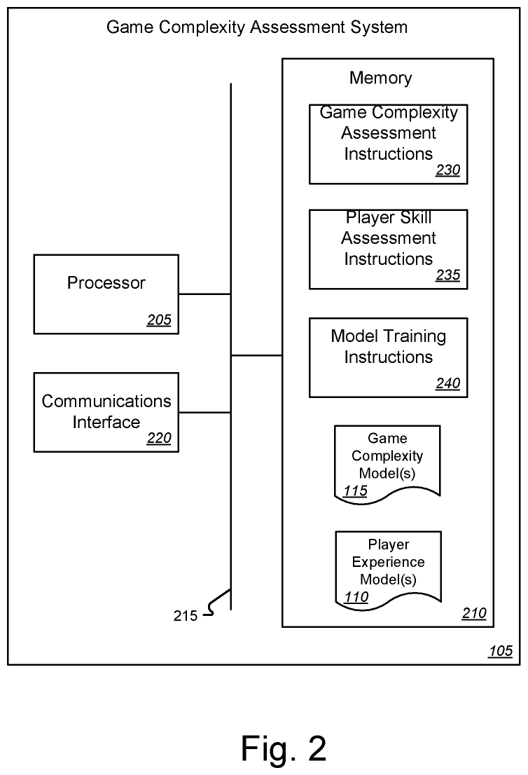

FIG. 2 is a block diagram illustrating additional detail of components of an exemplary game complexity assessment system according to one embodiment of the present disclosure. As illustrated in this example, a gaming complexity assessment system 105 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming complexity assessment system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 via the communications bus 215. The communication interface(s) 220 can comprise, for example, a Bluetooth, WiFi, cellular, and/or other type of wireless communications interface. Via the communication interface(s) 220, the game complexity assessment system can communication with gaming systems 125 and/or other devices and/or systems through a communications network 120 as described above.

The memory 210 can store therein a set of gaming complexity assessment instructions 230 which, when executed by the processor 205, cause the processor 205 to maintain a player experience model 110. The player experience model 110 can define a plurality of factors indicating player engagement with the electronic game. The game complexity assessment instructions 230 can further cause the processor 205 to receive information related to activity of a player 130 of the electronic game from a gaming system 125B during execution of the electronic game on the gaming system 125B and determine a player engagement level based on the received information related to the activity of the player 130 and the player experience model 110.

The game complexity assessment instructions 230 can further cause the processor 205 to make a determination as to whether the player engagement level is below a predetermined threshold level, i.e., the player 130 is less engaged than expected or desired. In response to determining the player engagement level is less than the predetermined threshold, the game complexity assessment instructions 230 can further cause the processor 205 to provide an instruction to the gaming system 125B to enable an additional, new feature in the electronic game. In some cases, the instruction can comprise an instruction to enable a feature of the electronic game already available on the gaming system 125B. In other cases, the instruction can comprise a download and installation of one or more features to the gaming system 125B. In some cases, the game complexity assessment instructions 230 can cause the processor to save the determined player engagement level in an electronic record 135 associated with the player 130, e.g., in a player account record for persistence of the skill level. This can then be applied to future play of the game. For example, when the player 130 starts the game again in the future, the game can begin at the same or slightly higher complexity level.

The memory 210 can further comprise a set of model training instructions 240 stored therein which, when executed by the processor 205, causes the processor 205 to train the player experience model 110 based on the received information related to the activity of the player 130. Additionally, or alternatively, the model training instructions 240 can cause the processor 205 to receive information related to activity of the player 130 of the electronic game related to the additional, new feature of the electronic game from the gaming system 125B during execution of the electronic game on the gaming system 125B and train the player experience model 110 based on the received information related to activity of the player 130 of the electronic game related to the additional, new feature of the electronic game.

The memory 210 can further comprise a set of player skill assessment instructions 235 stored therein which, when executed by the processor 205, causes the processor 205 to maintain a game complexity model 115. The game complexity model 115 can define a plurality of factors indicating player proficiency with the electronic game. The player skill assessment instructions 235 can further cause the processor 205 to receive information related to activity of a player 130 of the electronic game from a gaming system 125B during execution of the electronic game on the gaming system 125B and determine a player skill level based on the received information related to the activity of the player 130 and the game complexity model 115.

The player skill assessment instructions 235 can further cause the processor 205 to make a determination as to whether the determined player skill level is below a predetermined threshold level, i.e., the player 130 may be having trouble learning or understanding the game or a new game feature. In response to determining the player skill level is less than the predetermined threshold for a current level of the electronic game, the player skill assessment instructions 235 can cause the processor 205 to provide an instruction to the gaming system 125B to provide a tutorial to the player 130 of the electronic game. In some cases, the instructions can comprise an instruction to play or present an explanation and/or demonstration of the electronic game already available on the gaming system 125B. In other cases, the instruction can comprise a download and installation of one or more explanations and/or demonstration to the gaming system 125B to be presented to the player 130. In some cases, the player skill assessment instructions 235 can cause the processor 205 to save the determined player skill level in an electronic record 135 associated with the player 130, e.g., in a player account record for persistence of the skill level. This can be then applied to future play of the game. For example, when the player starts the game again in the future, the game can begin at the same or slightly higher complexity level.

The model training instructions 240 can cause the processor 205 to train the game complexity model 115 based on the received information related to the activity of the player 130. Additionally, or alternatively, the model training instructions 240 can cause the processor 205 to provide an instruction to collect information indicating a response by the player to the provided tutorial to the gaming system 125B. That is, a question soliciting feedback on the provided tutorial can be presented to the player 130 through the gaming system 125B. The model training instructions 240 can cause the processor 205 receive information indicating the response by the player 130 to the tutorial from the gaming system 125B and train the game complexity model 115 based on the received information indicating the response by the player 130 to the tutorial.

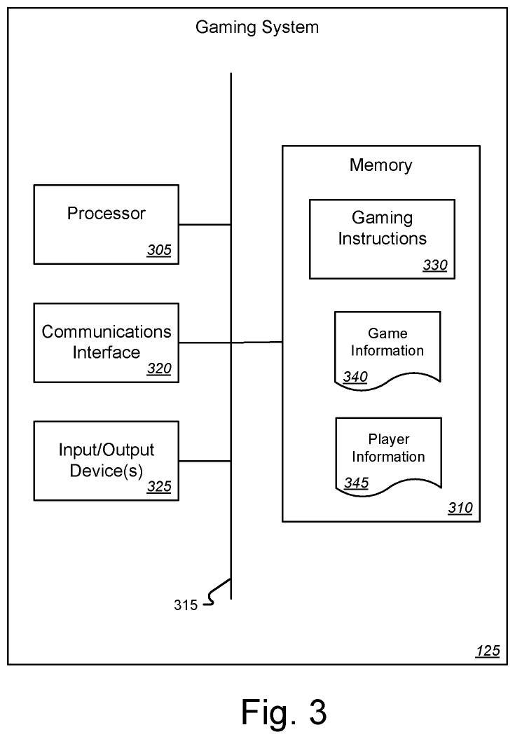

FIG. 3 is a block diagram illustrating additional details of components of an exemplary gaming system according to one embodiment of the present disclosure. As illustrated in this example, a gaming system, such as the second gaming system 125B described above, can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320 and one or more input/output devices 325 via the communications bus 315. The communication interfaces 320 can comprise, for example, a Bluetooth, WiFi, cellular, and/or other type of wireless communications interface. The input/output devices 325 can include, but are not limited to a display device such as a Liquid Crystal Display (LCD), Light Emitting Diode (LED), Organic Light Emitting Diode (OLED), or other type of display, a ticket printer, etc.

The memory 310 can store therein a set of gaming instructions 330 which, when executed by the processor 305, cause the processor 305 to execute an electronic game. The electronic game can be any of a wide variety of electronic games of chance including, but not limited to, slots, video slots, video poker, keno, blackjack, etc. to be played by a player, e.g., in a casino or other gaming venue. During execution of the electronic game, the gaming instructions 330 can cause the processor 305 to collect game information 340, e.g., game status, player actions, etc., as well as player information 345, e.g., a player ID and/or other identifying information, provide this information to the game complexity assessment system 105 through the communication interface(s) 320, receive, from the game complexity assessment system 105, via the communications interface(s) 320, instructions for implementing and/or enabling new features and/or providing tutorials in the electronic game etc. as described above.

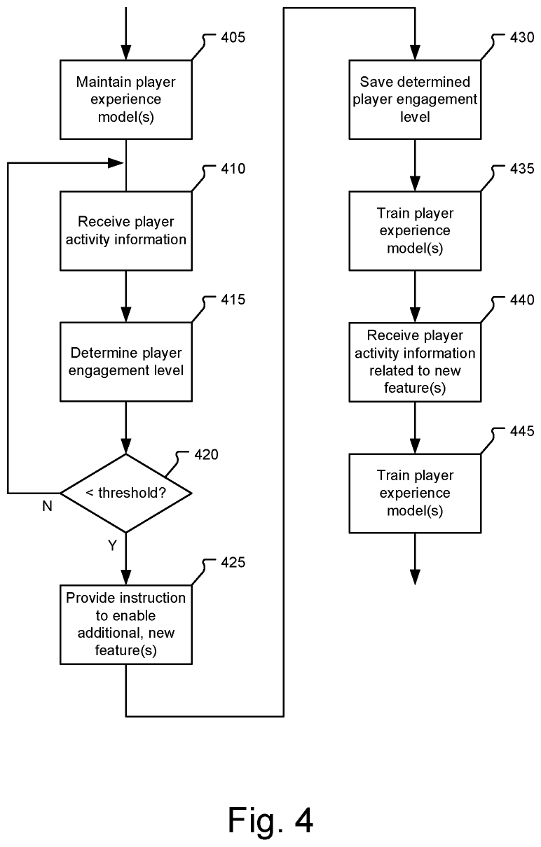

FIG. 4 is a flowchart illustrating an exemplary process for operating an electronic game according to one embodiment of the present disclosure. As illustrated in this example, operating an electronic game can comprise maintaining 405 a player experience model 110. The player experience model 110 can define a plurality of factors indicating player engagement with the electronic game. Information related to activity of a player 130 of the electronic game can be received 410 from a gaming system 125B during execution of the electronic game on the gaming system 125B. A player engagement level can be determined 415 based on the received information related to the activity of the player 130 and the player experience model 110.

A determination 420 can be made as to whether the determined 415 player engagement level is below a predetermined threshold level, i.e., the player 130 is less engaged than expected or desired. In response to determining 420 the player engagement level is less than the predetermined threshold, an instruction can be provided 425 to the gaming system 125B to enable an additional, new feature in the electronic game. In some cases, the instructions can comprise an instruction to enable a feature of the electronic game already available on the gaming system 125B. In other cases, the instruction can comprise a download and installation of one or more features to the gaming system 125B. In some cases, the determined player engagement level can be saved 430 in an electronic record associated with the player 130, e.g., in a player account record for persistence of the skill level. This can be then applied to future play of the game. For example, when the player 130 starts the game again in the future, the game can begin at the same or slightly higher complexity level.

The player experience model 110 can be trained 435 based on the received information related to the activity of the player 130. Additionally, or alternatively, information related to activity of the player 130 of the electronic game related to the additional, new feature of the electronic game can be received 440 from the gaming system 125B during execution of the electronic game on the gaming system 125B and the player experience model 110 can be trained 445 based on the received information related to activity of the player 130 of the electronic game related to the additional, new feature of the electronic game.

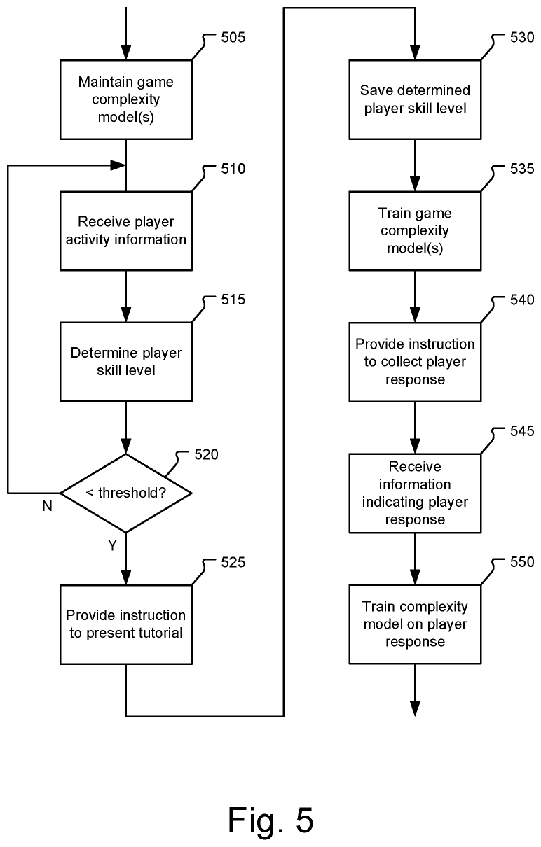

FIG. 5 is a flowchart illustrating an exemplary process for operating an electronic game according to another embodiment of the present disclosure. As illustrated in this example, a game complexity model 115 can also be maintained 505. The game complexity model 115 can define a plurality of factors indicating player proficiency with the electronic game. Information related to activity of a player 130 of the electronic game can be received 410 from a gaming system 125B during execution of the electronic game on the gaming system 125B and a player skill level can be determined 515 based on the received information related to the activity of the player 130 and the game complexity model 115.

A determination 520 can be made as to whether the determined 515 player skill level is below a predetermined threshold level, i.e., the player 130 may be having trouble learning or understanding the game or a new game feature. In response to determining 520 the player skill level is less than the predetermined threshold for a current level of the electronic game, an instruction can be provided 525 to the gaming system 125B to provide a tutorial to the player 130 of the electronic game. In some cases, the instructions can comprise an instruction to play or present an explanation and/or demonstration of the electronic game already available on the gaming system 125B. In other cases, the instruction can comprise a download and installation of one or more explanations and/or demonstration to the gaming system 125B to be presented to the player 130. In some cases, the determined player skill level can be saved 530 in an electronic record associated with the player 130, e.g., in a player account record for persistence of the skill level. This can be then applied to future play of the game. For example, when the player starts the game again in the future, the game can begin at the same or slightly higher complexity level.

The game complexity model 115 can be trained 535 based on the received information related to the activity of the player 130. Additionally, or alternatively, an instruction to collect information indicating a response by the player to the provided tutorial can be provided 540 to the gaming system 125B. That is, a question soliciting feedback on the provided tutorial can be presented to the player 130 through the gaming system 125B. Information indicating the response by the player 130 to the tutorial can be received 545 from the gaming system 125B. In such cases, the game complexity model 115 can be trained 550 based on the received information indicating the response by the player 130 to the tutorial.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for operating an electronic game, the method comprising:
maintaining, by a game complexity assessment system, a player experience model, the player experience model defining a plurality of factors indicating player engagement with the electronic game;
receiving, by the game complexity assessment system, from a gaming system, information related to activity of a player of the electronic game during execution of the electronic game on the gaming system;
determining, by the game complexity assessment system, a player engagement level based on the received information related to the activity of the player and the player experience model; and
in response to the determined player engagement level being less than a predetermined threshold, providing, by the game complexity assessment system, to the gaming system, an instruction to enable an additional, new feature in the electronic game.

2. The method of claim 1, further comprising:
maintaining, by the game complexity assessment system, a game complexity model, the game complexity model defining a plurality of factors indicating player proficiency with the electronic game;
determining, by the game complexity assessment system, a player skill level based on the received information related to the activity of the player and the game complexity model; and
in response to the determined player skill level being less than a predetermined threshold for a current level of the electronic game, providing, by the game complexity assessment system, to the gaming system, an instruction to provide a tutorial to the player of the electronic game.

3. The method of claim 1, further comprising training, by the game complexity assessment system, the player experience model based on the received information related to the activity of the player.

4. The method of claim 2, further comprising training, by the game complexity assessment system, the game complexity model based on the received information related to the activity of the player.

5. The method of claim 1, further comprising:
receiving, by the game complexity assessment system, from the gaming system, information related to activity of the player of the electronic game related to the additional, new feature of the electronic game during execution of the electronic game on the gaming system; and
training, by the game complexity assessment system, the player experience model based on the received information related to activity of the player of the electronic game related to the additional, new feature of the electronic game.

6. The method of claim 2, further comprising:
providing, by the game complexity assessment system, to the gaming system, an instruction to collect information indicating a response by the player to the provided tutorial;
receiving, by the game complexity assessment system, from the gaming system, the information indicating the response by the player to the tutorial; and
training, by the game complexity assessment system, the game complexity model based on the received information indicating the response by the player to the tutorial.

7. The method of claim 2, further comprising saving, by the game complexity assessment system, the determined player engagement level and the determined player skill level in an electronic record associated with the player.

8. A system comprising:
a communications interface;
a processor coupled with the communications interface; and
a memory coupled with and readable by the processor and storing therein a set of instructions which, when executed by the processor, causes the processor to:
maintain a player experience model, the player experience model defining a plurality of factors indicating player engagement with an electronic game;
receive, from a gaming system, information related to activity of a player of the electronic game during execution of the electronic game on the gaming system;
determine a player engagement level based on the received information related to the activity of the player and the player experience model; and
in response to the determined player engagement level being less than a predetermined threshold, provide, to the gaming system, an instruction to enable an additional, new feature in the electronic game.

9. The system of claim 8, wherein the instructions further cause the processor to:
maintain a game complexity model, the game complexity model defining a plurality of factors indicating player proficiency with the electronic game;
determine a player skill level based on the received information related to the activity of the player and the game complexity model; and
in response to the determined player skill level being less than a predetermined threshold for a current level of the electronic game, provide, to the gaming system, an instruction to provide a tutorial to the player of the electronic game.

10. The system of claim 8, wherein the instructions further cause the processor to train the player experience model based on the received information related to the activity of the player.

11. The system of claim 9, wherein the instructions further cause the processor to train the game complexity model based on the received information related to the activity of the player.

12. The system of claim 8, wherein the instructions further cause the processor to:
receive, from the gaming system, information related to activity of the player of the electronic game related to the additional, new feature of the electronic game during execution of the electronic game on the gaming system; and
train the player experience model based on the received information related to activity of the player of the electronic game related to the additional, new feature of the electronic game.

13. The system of claim 9, wherein the instructions further cause the processor to:
provide, to the gaming system, an instruction to collect information indicating a response by the player to the provided tutorial;
receive, from the gaming system, the information indicating the response by the player to the tutorial; and
train the game complexity model based on the received information indicating the response by the player to the tutorial.

14. The system of claim 9, wherein the instructions further cause the processor to save the determined player engagement level and the determined player skill level in an electronic record associated with the player.

15. A system comprising:
a communications network;
a gaming system communicatively coupled with the communications network and executing an electronic game; and
a game complexity assessment system coupled with the communications network and comprising a processor and a memory, the memory storing therein a set of instructions which, when executed by the processor, causes the processor to:
maintain a player experience model, the player experience model defining a plurality of factors indicating player engagement with the electronic game;
receive, from a gaming system, via the communications network, information related to activity of a player of the electronic game during execution of the electronic game on the gaming system;
determine a player engagement level based on the received information related to the activity of the player and the player experience model; and
in response to the determined player engagement level being less than a predetermined threshold, provide, to the gaming system, via the communications network, an instruction to enable an additional, new feature in the electronic game.

16. The system of claim 15, wherein the instructions further cause the processor to:
maintain a game complexity model, the game complexity model defining a plurality of factors indicating player proficiency with the electronic game;
determine a player skill level based on the received information related to the activity of the player and the game complexity model; and
in response to the determined player skill level being less than a predetermined threshold for a current level of the electronic game, provide, to the gaming system, via the communications network, an instruction to provide a tutorial to the player of the electronic game.

17. The system of claim 15, wherein the instructions further cause the processor to train the player experience model based on the received information related to the activity of the player.

18. The system of claim 17, wherein the instructions further cause the processor to train the game complexity model based on the received information related to the activity of the player.

19. The system of claim 15, wherein the instructions further cause the processor to:
receive, from the gaming system, via the communications network, information related to activity of the player of the electronic game related to the additional, new feature of the electronic game during execution of the electronic game on the gaming system; and
train the player experience model based on the received information related to activity of the player of the electronic game related to the additional, new feature of the electronic game.

20. The system of claim 19, wherein the instructions further cause the processor to:
provide, to the gaming system, via the communications network, an instruction to collect information indicating a response by the player to the provided tutorial;
receive, from the gaming system, via the communications network, the information indicating the response by the player to the tutorial; and
train the game complexity model based on the received information indicating the response by the player to the tutorial.
